(19) United States
(12) Patent Application Publication
(10) Pub. No.: US 2010/0133467 A1
(43) Pub. Date: Jun. 3, 2010

(54) COMPOUND HAVING OLIVINE-TYPE STRUCTURE, POSITIVE ELECTRODE FOR NONAQUEOUS ELECTROLYTE SECONDARY BATTERY, AND NONAQUEOUS ELECTROLYTE SECONDARY BATTERY

(75) Inventor: Atsushi IKEGAWA, KOBE-SHI (JP)

Correspondence Address: SUGHRUE MION, PLLC, 2100 PENNSYLVANIA AVENUE, N.W., SUITE 800, WASHINGTON, DC, 20037, US

(73) Assignee: SANTOKU CORPORATION, KOBE-SHI, HYOGO (JP)

(21) Appl. No.: 12/528,950

(22) PCT Filed: Feb. 28, 2008
(86) PCT No.: PCT/JP2008/053483

§ 371 Date: Oct. 13, 2009

(30) Foreign Application Priority Data
Feb. 28, 2007 (JP) 2007-049715

(51) Int. Cl. H01M 4/58; C01B 25/30

(52) U.S. Cl. 252/182.1; 428/220

(57) ABSTRACT

Disclosed is a compound having the olivine structure with which batteries having high capacity, high output, and excellent high rate performance may be produced, as well as a cathode for nonaqueous electrolyte rechargeable batteries produced with this compound, and a nonaqueous electrolyte rechargeable battery provided with this cathode. The present compound is LiFePO₄ and the like, which contains at least lithium, a transition metal, phosphorus, and oxygen; has the olivine structure; hardly contains a crystal phase other than the olivine phase; and has a specific surface area of not smaller than 4 m²/g; and is useful as a cathode active material of nonaqueous electrolyte rechargeable batteries.

### FIELD OF ART

The present invention relates to a nonaqueous electrolyte rechargeable battery, such as lithium ion rechargeable batteries, a compound having the olivine structure used therefor, and a cathode.

### BACKGROUND ART

Lithium ion rechargeable batteries, which are a nonaqueous electrolyte rechargeable battery, are widely used in portable electronic devices, such as video cameras, portable audio players, mobile phones, and notebook computers, which have been made smaller, lighter, and more powerful. For electronic and hybrid vehicles as well as motor-assisted bicycles, development of lithium ion rechargeable batteries having high capacity and improved cycle characteristics and high rate performance are urgently desired. It is also an important challenge to reduce the use of rare metals, such as nickel and cobalt, for conservation of natural resources and environment.

In view of the above, lithium ion rechargeable batteries are proposed, which employ, as a cathode active material, LiFePO₄, LiFeVO₄, and the like compounds having the olivine structure. The compounds contain iron, which is available in abundance and inexpensive, as a main component in place of nickel and cobalt.

Patent Publication 1 proposes a method for producing a cathode active material for lithium ion rechargeable batteries which achieves excel lent battery characteristics at low cost. According to this method, a lithium compound, such as lithium carbonate, a divalent iron compound, such as ferrous phosphate, and a phosphate compound, such as ammonium hydrogenphosphate, are mixed and calcined.

Patent Publication 2 proposes LiFePO₄ having a normal particle size distribution with the median size of not larger than 5.3 μm as determined by laser diffraction, which is described to be a cathode active material high in capacity and small in lot-to-lot variation of particle diameters and particle size distributions.

Patent Publication 3 proposes a cathode active material, such as LiFePO₄, which has small particle diameters, good crystallinity, high capacity, and excellent charge/discharge characteristics.

In Patent Publications 2 and 3, methods for producing LiFePO₄ are disclosed, which include heating lithium, iron, and phosphate compounds similar to those disclosed in Patent Publication 1, in an autoclave to react. The disclosed cathode active materials, such as LiFePO₄, have been confirmed to have the olivine structure by powder X-ray diffraction.

Patent Publication 1: JP-9-171827-A

Patent Publication 2: JP-2002-151082-A

Patent Publication 3: JP-2004-95385-A

However, these cathode active materials may include phases other than the olivine phase, or may not be crystallized sufficiently in part when observed microscopically, though not confirmable by powder X-ray diffraction. The presence of insufficiently crystallized part tends to hinder intercalation/deintercalation of Li, which adverse effect is characteristically seen on a charge/discharge curve. Specifically, when there is a different phase or insufficiently crystallized part, the voltage starts to increase gradually at an early stage of charging, and to decrease gradually at an early stage of discharging.

These cathode active materials, such as LiFePO₄, have large primary and/or secondary particles, and small specific surface areas. Thus, even if conductivity is imparted with an electrical conductivity assisting agent, sufficient discharge capacity and high rate performance cannot be achieved.

It is an object of the present invention to provide a compound having the olivine structure which exhibits high capacity, high output, and excellent high rate performance when used as a cathode active material of a nonaqueous electrolyte rechargeable battery, as well as a cathode for nonaqueous electrolyte rechargeable batteries containing this compound, and a nonaqueous electrolyte rechargeable battery provided with this cathode.

### SUMMARY OF THE INVENTION

According to the present invention, there is provided a compound having an olivine structure comprising at least lithium, a transition metal, phosphorus, and oxygen, said compound having an olivine structure and a specific surface area of not smaller than 4 m²/g, wherein a highest peak intensity (I1) observed in the range of 2θ=23.00° to 23.70°, a highest peak intensity (I2) observed in the range of 2θ=21.40° to 22.90° , and a highest peak intensity (I3) observed in the range of 2θ=17.70° to 19.70° satisfy I1/I2 of not more than 0.050 and I3/I2 of not more than 0.001, as determined by X-ray diffraction under the following conditions:

### Conditions for X-Ray Diffraction

target: copper; tube voltage: 40 kV; tube current: 300 mA; divergence slit: ½°; scattering slit: 1°; receiving slit: 0.15 mm; operation mode: FT; scan step: 0.01°; exposure time: 2 seconds.

According to the present invention, there is also provided a cathode for nonaqueous electrolyte rechargeable batteries comprising the above-mentioned compound having an olivine structure.

According to the present invention, there is further provided a nonaqueous electrolyte rechargeable battery comprising the above-mentioned cathode.

The compound having the olivine structure according to the present invention, when used in a cathode for nonaqueous electrolyte rechargeable batteries, provides high capacity and output and excellent high rate performance, and thus extremely useful for nonaqueous electrolyte rechargeable batteries.

### BRIEF DESCRIPTION OF THE DRAWINGS

FIG. 1 is a chart showing the charge/discharge curves at the 10th cycle of LiFePO₄ prepared in Example 1 and Comparative Example 1.

FIG. 2 is a chart showing the powder X-ray diffraction pattern of LiFePO₄ prepared in Example 1.

FIG. 3 is a chart showing enlarged X-ray diffraction patterns in the range of 2θ=15° to 29° of LiFePO₄ prepared in Example 1 and Comparative Example 1.

FIG. 4 is a chart showing the powder X-ray diffraction pattern of LiFePO₄ prepared in Comparative Example 3.

### EMBODIMENTS OF THE INVENTION

The present invention will now be explained in detail.

The compound having the olivine structure according to the present invention contains at least lithium, a transition metal, phosphorus, and oxygen. The transition metal may preferably be one or more metals selected from Sc, Y, lanthanoids of atomic numbers of 57 to 71, Ti, Zr, Hf, V, Nb, Ta, Cr, Mo, W, Mn, Fe, Co, Ni, and Cu.

The compound of the present invention may optionally contain elements of groups 1, 2, and 12 to 17, for achieving desired properties. For conservation of natural resources, it is preferred to use Fe, which is available in abundance. LiFePO₄ is a typical compound having the olivine structure according to the present invention.

In LiFePO₄, part of Fe may be substituted with other elements. For example, substitution with Mn improves the cycle characteristics; substitution with Al, Mg, Ca, and/or Ni increases the capacity; substitution with Bi improves the cycle characteristics and increases the capacity; substitution with Ti, Zr, and/or Nb increases the electronic conductivity and improves the cycle characteristics and the high rate performance.

Examples of the compound in which part of Fe is substituted with other elements may include LiFe_{0.8}Mn_{0.2} PO₄, LiFe_{0.8}Cr_{0.2}PO₄, LiFe_{0.8}Co_{0.2}PO₄, LiFe_{0.8}Cu_{0.2}PO₄, LiFe_{0.8}Ni_{0.2}PO₄, LiFe_{0.75}V_{0.25}PO₄, LiFe_{0.75}Mo_{0.25}PO₄, LiFe_{0.75}Ti_{0.25}PO₄, LiFe_{0.7}Zn_{0.3}PO₄, LiFe_{0.7}Al_{0.3}PO₄, LiFe_{0.7}Ga_{0.3}PO₄, LiFe_{0.75}Mg_{0.25}PO₄, LiFe_{0.75}B_{0.25}PO₄, and LiFe_{0.75}Nb_{0.25}PO₄.

The compound of the present invention hardly contains crystal phases other than the olivine phase. The little presence of crystal phases other than the olivine phase may be verified by the ratios between the intensities of the three particular diffraction peaks observed in X-ray diffraction under the conditions mentioned below.

The conditions for X-ray diffraction are; target: copper; tube voltage: 40 kV; tube current: 300 mA; divergence slit: ½°; scattering slit: 1°; receiving slit: 0.15 mm; operation mode: FT; scan step: 0.01°; and exposure time: 2 seconds.

The three peaks employed in the verification are the highest peak observed in the range of 2θ=23.00° to 23.70°, the highest peak in the range of 2θ=21.40° to 22.90°, and the highest peak in the range of 2θ=17.70° to 19.70°. Denoting the intensities of these peaks by I1, I2, and I3, the compound having the olivine structure according to the present invention satisfies I1/I2 of not more than 0.050 and I3/I2 of not more than 0.001, preferably I1/I2 of not more than 0.010.

For Example, in the case of LiFePO₄, the highest peak observed in the range of 2θ=23.00° to 23.70° corresponds to a phase other than LiFePO₄, such as the (101) plane of Li₃PO₄; the highest peak observed in the range of 2θ=21.40° to 22.90° corresponds to the (210) plane of LiFePO₄; and the highest peak observed in the range of 2θ=17.70° to 19.70° corresponds to the (200) plane of FePO₄. Thus, when I1/I2 is not more than 0.050 and I3/I2 is not more than 0.001, it means that little impurity phases are present aside from the LiFePO₄ phase.

The specific surface area of the compound according to the present invention is not smaller than 4.0 m²/g, preferably not smaller than 6.0 m²/g, more preferably not smaller than 8.0 m²/g. The specific surface area has been determined by the BET method.

Smaller primary particles cause shorter diffusion length of Li in the charge/discharge reaction and larger specific surface area, which results in larger reaction area of Li and improved high rate performance. It is thus preferred for the compound of the present invention to have smaller primary particles and larger specific surface area. However, due to its excellent overall crystallinity, the present compound achieves high capacity, high output, and excellent high rate performance with a specific surface area of not smaller than 4.0 m² /g. For obtaining compounds of such excellent crystallinity without formation of different phases, it is industrially preferred that the specific surface area is not larger than 15.0 m²/g.

The compound according to the present invention preferably has excellent overall crystallinity. Microscopic difference in crystallinity between the present compound and a conventional compound cannot be verified by powder X-ray diffraction. Thus the crystallinity of the present compound was evaluated by the following charge/discharge test.

The charge/discharge test was conducted through following steps (1) to (5):

(1) The compound containing at least lithium, a transition metal, phosphorus, and oxygen and having the olivine structure was dispersed in a 10 mass % aqueous glucose solution at a compound-to-carbon ratio of 98.5:1.5 by mass. The dispersion was dried under stirring, and subjected to reducing treatment under 5 vol % hydrogen-argon mixed gas atmosphere at 800° C. for 1 hour.
(2) The compound obtained from step (1) was mixed with acetylene black as an electrically conductive material and polyvinylidene fluoride as a binder at the ratio of 80:15:5 by mass, and the mixture was kneaded with N-methylpyrrolidone into slurry. The resulting electrode slurry was applied to 20 μm thick aluminum foil, dried, and pressure molded in a press into a thickness of 60 μm. Then a Φ12 mm piece was punched out of the molded product as a cathode having a density of 1.830 to 1.920 g/cm³ exclusive of the aluminum foil. A Φ14 mm piece was punched out of 0.15 mm thick lithium foil as an anode, and porous non-woven polypropylene cloth of 0.025 mm thick was used as a separator. These electrodes were placed in a 2032 coin cell, which was charged with an electrolyte prepared by dissolving lithium hexafluorophosphate at 1 mol/l in a 1:2 by volume mixed solution of ethylene carbonate and dimethylcarbonate, to thereby obtain a nonaqueous electrolyte rechargeable battery.
(3) The nonaqueous electrolyte rechargeable battery prepared in step (2) was subjected to constant current charge up to a cathode potential against the anode of 4.5 V and then to constant voltage charge down to a cathode current density of not higher than 0.010 mA/cm², at 0.2 C at a constant temperature of 25° C.
(4) After the charge in step (3), the battery was discharged at 0.2 C down to a cathode potential against the anode of 2.5 V at a constant temperature of 25° C.
(5) Steps (3) and (4) were repeated.

In step (1) , the compound containing at least lithium, a transition metal, phosphorus, and oxygen and having the olivine structure is at least partially coated on its surface with an electrically conductive substance, such as carbon. Compounds having the olivine structure, such as LiFePO₄, are low in electronic conductivity. Thus the compound is given electronic conductivity through this step.

In step (2), a cathode is prepared with the compound given electronic conductivity in step (1) as a cathode active material, an anode is prepared with lithium metal, and a 2032 coil cell is prepared with these electrodes.

In steps (3), (4), and (5), a charge/discharge test is conducted on the coin cell prepared in step (2), and the conditions thereof are defined.

When the coin cell prepared in steps (1) and (2) is charged in step (3), discharged in step (4), and then charged in step (3) to thereby be subjected to repeated steps (3) and (4) as a cycle, the compound with the olivine structure according to the present invention enables the cell to be charged to not less than 91.0%, preferably not less than 93.0% of its theoretical capacity within a cathode potential against the anode of 4.0 V in step (3) at the 10th cycle. More preferably, the compound of the present invention enables the cell to be charged to not less than 90.0%, preferably not less than 91.0% of its theoretical capacity within a cathode potential against the anode of 3.8 V in step (3) at the 10th cycle.

Here, the theoretical capacity is the battery capacity to be reached when all Li contained in the compound of the present invention is involved in the charge/discharge reaction.

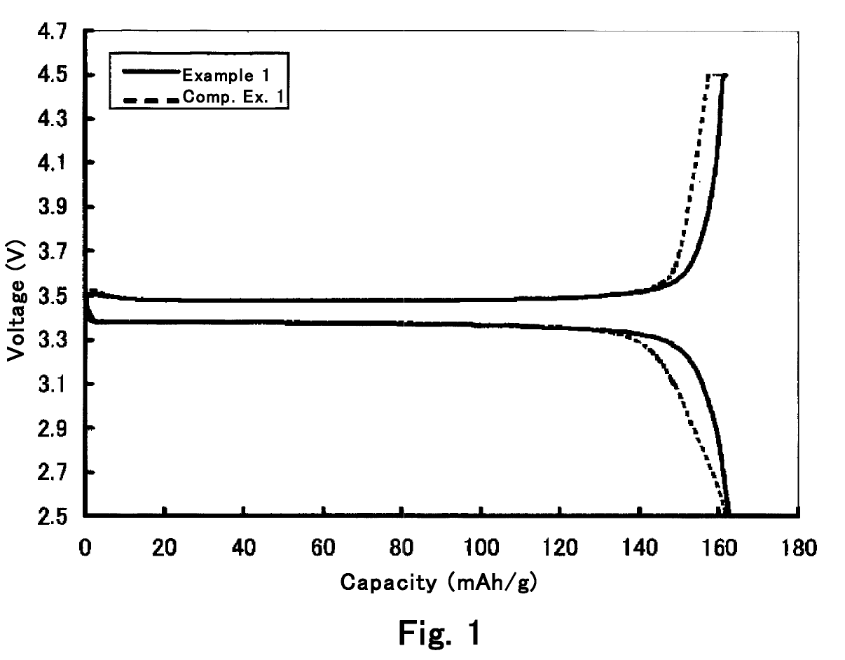

FIG. 1 shows the charge/discharge curves at the 10th cycle of charge/discharge of the cells prepared with the compounds in Example 1 and Comparative Example 1 to be discussed later. When a potential of 4.0 V is reached, the charge capacity of the cell with the compound of Example 1 is 158.6 mAh/g (93.3% of the theoretical capacity), whereas that of Comparative Example 1 is 153.4 mAh/g (90.2% of the theoretical capacity). When a potential of 3.8 V is reached, the charge capacity of the cell with the compound of Example 1 is 156.3 mAh/g (91.9% of the theoretical capacity), whereas that of Comparative Example 1 is 151.5 mAh/g (89.1% of the theoretical capacity). The discharge curves of the two cells are observed to generally match, i.e., the two cells are at the same discharge potential, from the start of discharge up to 125 mAh/g (73.5% of the theoretical capacity). However, from 125 mAh/g (73.5% of the theoretical capacity), the discharge potential of the cell of Comparative Example 1 is gradually lowered toward the end of discharge. In contrast, the cell of Example 1 is discharged further without decline of the discharge potential, and from about 145 mAh/g (85.3% of the theoretical capacity) the potential is lowered toward the end of discharge.

Such large charge/discharge capacities achieved by using the present compound with the olivine structure as demonstrated by these results, are believed to be ascribable to smooth intercalation/deintercalation of Li both near the surface of and inside of the compound, due to the excellent crystallinity over the entire compound.

The present compound with the olivine structure is preferably provided with an electrically conductive substance at least partly over its surface. The electrically conductive substance may be any material having electronic conductivity, and may be selected from a variety of materials, for example, Fe, Ni, Cu, Ti, Au, Ag, Pd, Pt, Ir, Ta, carbon, and Al, either alone, alloyed, or chemically combined. Among these, carbonaceous materials are preferred. The carbonaceous materials, which contain carbon and have electronic conductivity, may preferably be materials having not less than 50 mass % carbon content. Examples of the carbonaceous materials may include carbon black, such as acetylene black and furnace black, carbon nanotubes, fullerene, and graphite.

The present compound may be provided with the electrically conductive substance at least partly over its surface by, for example, coating the compound with the electrically conductive substance. The coating may be carried out by, for example, plating or vapor deposition of the present compound with the electrically conductive substance, or mixing the present compound and the electrically conductive substance in a ball mill or the like device.

When the electrically conductive substance is a carbonaceous material, the coating may be carried out by immersing the present compound in a solution of a carbon-containing material, such as sugars, including alginic acid or glucose, drying under stirring, and reducing in a heating furnace under controlled atmosphere. Such a method is preferred since the surface of the compound may be uniformly coated with the carbonaceous material.

In coating, if the controlled atmosphere is simply an inert gas atmosphere, the reduction of the sugars may cause oxidation reaction at the surface of the compound with the olivine structure, which may result in lowered capacity or deterioration of high rate performance. It is thus preferred to control the atmosphere to a mixed gas atmosphere of hydrogen and an inert gas.

The electrically conductive substance per se does not contribute to the discharge capacity, so that too much coating will lower the discharge capacity per unit weight or volume of the compound having the olivine structure coated with the electrically conductive substance. Thus the amount of the electrically conductive substance is preferably as little as possible so long as sufficient charge/discharge reaction is induced.

When the coating is carried out by mixing in a ball mill or the like device, the electrically conductive substance is preferably in the form of as fine a powder as possible and applied as uniformly as possible, for imparting higher conductivity with a smaller amount.

The method for producing the present compound with the olivine structure is not particularly limited as long as the compound of the present invention is obtained. For example, the compound may be produced by a method including the steps of mixing a lithium compound as a lithium source, a transition metal compound as a transition metal source, and a phosphate compound as a phosphorus source, and calcining the mixture or heat-treating the mixture in a solvent. For excellent crystallinity throughout the compound, it is preferred to heat-treat the raw material compounds in a solvent.

Examples of the lithium compound may include inorganic salts, such as lithium hydroxide, lithium chloride, lithium nitrate, lithium carbonate, and lithium sulfate; and organic salts, such as lithium formate, lithium acetate, and lithium oxalate.

Examples of the transition metal compound may include oxides, hydroxides, carbonates, and oxyhydroxides of a transition metal. Compounds of a divalent transition metal are preferred. When the transition metal is iron, iron fluoride, iron chloride, iron bromide, iron iodide, iron sulfate, iron phosphate, iron oxalate, and iron acetate are preferred.

Examples of the phosphate compound may include orthophosphoric acid, metaphosphoric acid, pyrophosphoric acid, triphosphoric acid, tetraphosphoric acid, ammonium phosphate, ammonium phosphate dibasic, ammonium dihydrogen phosphate, lithium phosphate, and iron phosphate.

When the present compound contains an element other than lithium, transition metal, and phosphorus, such element may be in the form of the element per se, or oxides, hydroxides, carbonates, sulfates, nitrates, or halides containing such element, depending on the selected element.

The method for producing the present compound by heat-treating the raw material compounds in a solvent will now be discussed in detail.

The heat treatment may be performed at 80 to 300° C. for 3 to 48 hours under inert gas atmosphere. After the heat treatment, the resulting product is cooled, separated by filtration, washed, and dried, to give the present compound.

The heat treatment may preferably be carried out by sealing the raw material compounds and a solvent in an autoclave under inert gas atmosphere, and heat-treating the vessel under a pressure of not lower than 1 atm. In this case, the heat treatment is preferably carried out usually at 100 to 250° C. for 5 to 20 hours, more preferably at 120 to 180° C. for 7 to 15 hours.

Examples of the solvent may include water, methanol, ethanol, 2-propanol, ethylene glycol, propylene glycol, acetone, cyclohexane, 2-methylpyrrolidone, ethyl methyl ketone, 2-ethoxy ethanol, propylene carbonate, ethylene carbonate, dimethyl carbonate, dimethylformamide, and dimethylsulfoxide, either alone or in mixture of two or more of these.

For producing a compound of the present invention containing iron as the transition metal, it is preferred to mix a lithium compound, a divalent iron compound, and a phosphorus compound mentioned above in a solvent, and react in an autoclave under inert gas atmosphere.

The mixing ratio of the raw material compounds may be adjusted so as to ultimately produce the objective compound with the olivine structure, LiFePO₄. For example, a divalent iron compound and a phosphorus compound may be mixed so that the molar ratio of iron to phosphorus is about 1:1, and the lithium content may suitably be adjusted. Specifically, a solution of Li₃PO₄ and a divalent iron compound in water as a solvent with the molar ratio of iron to phosphorus of about 1:1, may be used.

Here, it is preferred for efficient production of the present compound to control pH of the solution such that Li₃PO₄ is in the solid state while the divalent iron compound is in the ionized state.

The pH of the solution is preferably 3.7 to 6.8, more preferably 4.5 to 6.0. This pH is preferably controlled so as not to be changed drastically before and after the heat treatment. If the heat treatment is performed in the pH range wherein the divalent iron compound is in a solid state, compounds other than those of the olivine structure may be formed, which is not preferred. At lower pH, the crystallinity throughout the compound tends to be higher, but the specific surface area may be smaller due to growth of the primary particles. At higher pH, the primary particles tend to be smaller and thus the specific surface area tends to be larger, but the secondary particles may grow too much, the crystallinity of the compound may be lower, and compounds other than those of the olivine structure may be formed.

The compound of the present invention, which is further provided with an electrically conductive substance at least partly over its surface, may be prepared by adding the electrically conductive substance mentioned above to the solution discussed above before the heat treatment. In particular, when the electrically conductive substance is in the form of fine powder, the electrically conductive substance is well dispersed over the surface of the present compound.

The inert gas atmosphere for the heat treatment may be controlled by introducing into the autoclave one or a mixture of two or more of the inert gases, such as nitrogen, argon, helium, and carbon dioxide gases. Further, a reducing compound, such as ascorbic acid or erythorbic acid, may be added to the solvent.

The cathode for nonaqueous electrolyte rechargeable batteries according to the present invention contains the present compound having the olivine structure. With the present compound, the cathode of the present invention provides high capacity, high output, and excellent high rate performance.

The cathode of the present invention may be prepared by kneading a compound with the olivine structure according to the present invention, an electrically conductive material, a binder, and other material s in an organic solvent into slurry, applying the slurry to an electrode plate, drying, rolling, and cutting into a predetermined size. The cathode may be adjusted to have a thickness of usually 50 to 100 μm.

The electrically conductive material, the binder, the organic solvent, and the electrode plate may be conventional ones.

Examples of the electrically conductive material may include carbonaceous materials, such as natural graphite, artificial graphite, Ketjen black, and acetylene black.

Examples of the binder may include fluororesins, such as polytetrafluoroethylene and polyvinylidene fluoride; polyvinyl acetate, polymethyl methacrylate, styrene-butadiene copolymer, acrylonitrile-butadiene copolymer, and carboxymethyl cellulose.

Examples of the organic solvent may include N-methylpyrrolidone, tetrahydrofuran, ethylene oxide, methyl ethyl ketone, cyclohexanone, methyl acetate, methyl acrylate, diethyltriamine, dimethylformamide, and dimethylacetamide.

Examples of the electrode plate may include metal foils, such as Al, Cu, and stainless steel foils. Aluminum foil of 10 to 30 μm thick is particularly preferred.

The nonaqueous electrolyte rechargeable battery according to the present invention is provided with the cathode of the present invention discussed above. With the present cathode, the battery of the present invention exhibits high capacity, high output, and excellent high rate performance.

The battery of the present invention is composed mainly of the cathode, an anode, an organic solvent, an electrolyte, and a separator. The organic solvent and the electrolyte may be replaced with a solid electrolyte.

Commonly known anode, organic electrolyte, electrolyte, and separator may be used.

The anode contains, as an anode active material, lithium metal, lithium alloys, or carbonaceous material, such as amorphous carbon including soft carbon and hard carbon, artificial graphite, or natural graphite. A binder, an electrode plate, and the like, similar to those for the cathode, may optionally be used.

Examples of the organic solvent may include carbonates, such as propylene carbonate, ethylene carbonate, dimethyl carbonate, diethyl carbonate, and ethyl methyl carbonate; ethers, such as 1,2- or 1,3-dimethoxypropane, tetrahydrofuran, and 2-methyltetrahydrofuran; esters, such as methyl acetate and γ-butyrolactone; nitriles, such as acetonitrile and butylonitrile; and amides, such as N,N-dimethylformamide and N,N-dimethylacetamide.

Examples of the electrolyte may include LiClO₄, LiPF₆, and LiBF₄.

Examples of the solid electrolyte may include polymer electrolytes, such as polyethylene oxide electrolyte; and sulfate electrolytes, such as Li₂S—SiS₂, Li₂S—P₂S₅, and Li₂S—B₂S₃. Alternatively, a so-called gel-type electrolyte, wherein a nonaqueous electrolyte solution is retained in a polymer, may also be used.

Examples of the separator may include porous polymer membranes, such as of polyethylene or polypropylene, and ceramics-coated porous sheets.

The nonaqueous electrolyte rechargeable battery according to the present invention may take various shapes, such as cylindrical, laminated, and coin shapes. In any shape, the nonaqueous electrolyte rechargeable battery of the present invention may be fabricated by placing the above-mentioned constituent components in a battery case, connecting the cathode and the anode to a cathode terminal and an anode terminal, respectively, with collector leads, and sealing the battery case.

### EXAMPLES

The present invention will now be explained in more detail with reference to Examples, which are not intended to limit the present invention.

### Example 1

Solution 1 of lithium hydroxide monohydrate dissolved in distilled water at 4.5 mol/dm³, Solution 2 of phosphoric acid diluted with distilled water to 1.5 mol/dm³, and Solution 3 of ferrous sulfate heptahydrate and ascorbic acid dissolved in distilled water at 1.5 mol/dm³ of ferrous sulfate and 0.005 mol/dm³ of ascorbic acid were prepared. Solutions 1 to 3 were mixed under stirring, and adjusted to pH 5.7, to thereby obtain a precursor slurry.

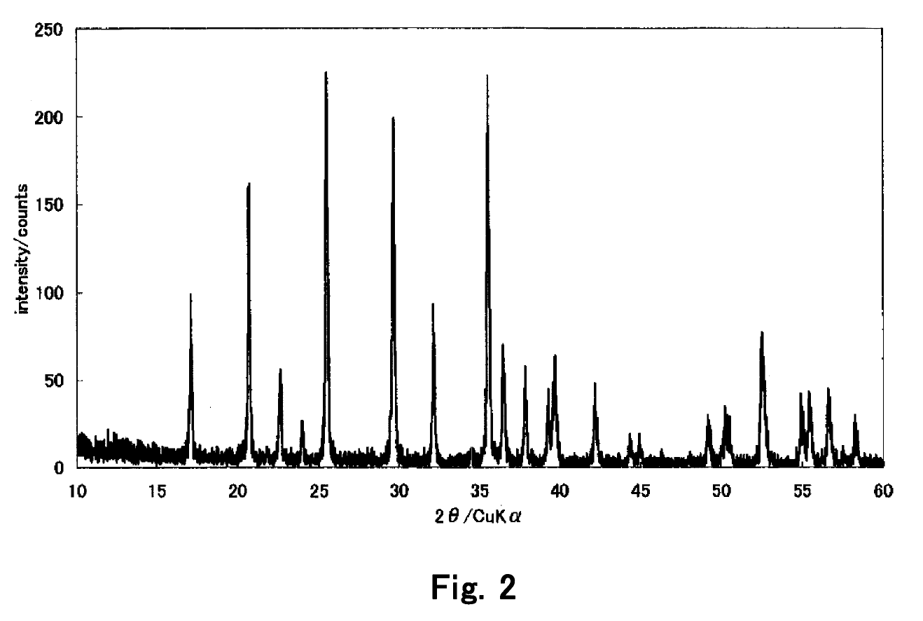

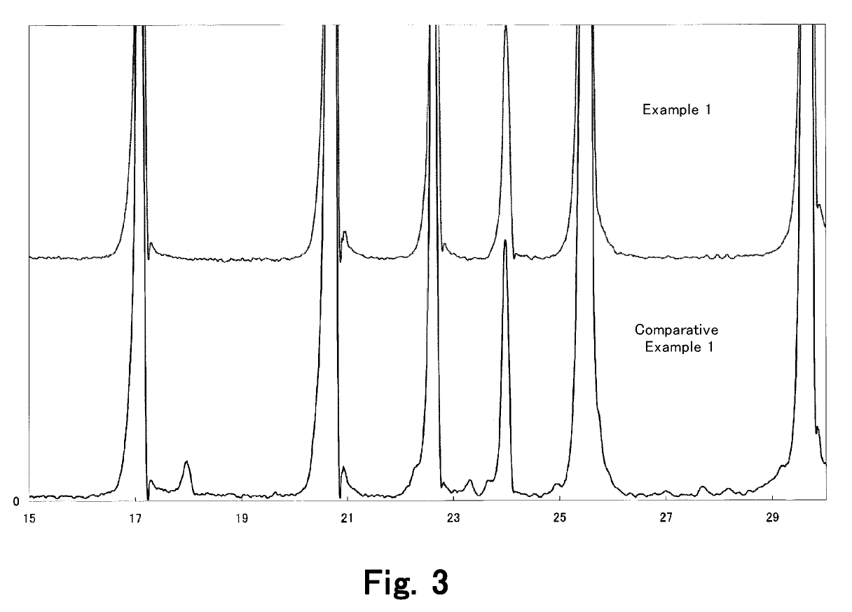

The precursor slurry thus obtained was placed in an autoclave, heat-treated at 170° C. for 15 hours under argon gas atmosphere under stirring, and cooled. The reaction product was washed with distilled water, subjected to filtration, and vacuum dried to obtain LiFePO₄. The LiFePO₄ was subjected to powder X-ray diffraction under Conditions A and B specified below. The resulting X-ray diffraction patterns are shown in FIG. 2 and FIG. 3, respectively. FIG. 3 is an enlarged diffraction pattern in the range of 2θ=15° to 29°. The highest peak intensity I1 observed in the range of 2θ=23.00° to 23.70°, the highest peak intensity I2 in the range of 2θ=21.40° to 22.90°, and the highest peak intensity I3 in the range of 2θ=17.70° to 19.70° as measured under Condition B were determined. The peak intensity ratio I1/I2 was 0.0079, and the peak intensity ratio I3/I2 was not higher than 0.001.

Further, the specific surface area of the compound was measured by the BET method, and determined to be 6.45 m²/g.

### <Condition A>

X-ray diffractometer: RINT1100 manufactured by RIGAKU CORPORATION; target: copper; tube voltage: 40 kV; tube current: 40 mA; divergence slit: 1°; scattering slit: 1°; receiving slit: 0.15 mm; operation mode: continuous; scan step: 0.01°; scan speed: 5°/min

### <Condition B>

X-ray diffractometer: RINT2500 manufactured by RIGAKU CORPORATION; target: copper; tube voltage: 40 kV; tube current: 300 mA; divergence slit: ½°; scattering slit: 1°; receiving slit: 0.15 mm; operation mode: FT; scan step: 0.01°; exposure time: 2 seconds

Next, to the obtained LiFePO₄, 10 mass % glucose solution was added at the carbon content of 1.5 mass %, which was then vacuum dried under stirring at 80° C. The resulting dry powder was calcined in a 5 vol % hydrogen-argon mixed gas flow at 800° C. for 1 hour, and loosened, to thereby obtain LiFePO₄ coated with the carbonaceous material.

The obtained LiFePO₄ coated with the carbonaceous material, acetylene black as an electrically conductive material, and polyvinylidene fluoride as a binder were mixed at the ratio of 80:15:5 by mass, kneaded with N-methylpyrrolidone, to prepare an electrode slurry.

The resulting electrode slurry was applied to 20 μm thick aluminum foil, dried, and pressure molded in a press into a thickness of 60 μm. Then a Φ12 mm piece was punched out of the molded product as a cathode having a density of 1.830 to 1.920 g/cm³ exclusive of the aluminum foil. A Φ14 mm piece was punched out of 0.15 mm thick lithium foil as an anode, and porous non-woven polypropylene cloth of 0.025 mm thick was used as a separator.

These electrodes, including the cathode, anode and separator, were placed in a 2032 coin cell, which was charged with an electrolyte prepared by dissolving lithium hexafluorophosphate at 1 mol/l in a 1:2 by volume mixed solution of ethylene carbonate and dimethylcarbonate, to thereby obtain a nonaqueous electrolyte rechargeable battery.

The obtained nonaqueous electrolyte rechargeable battery was subjected to constant current charge up to a cathode potential against the anode of 4.5 V and then to constant voltage charge down to a cathode current density of not higher than 0.010 mA/cm², at 0.2 C at a constant temperature of 25° C. After that, the battery was discharged at 0.2 C down to a cathode potential against the anode of 2.5 V at a constant temperature of 25° C. Charging and discharging as a cycle were repeated under the above conditions. The charge/discharge curve at the 10th cycle is shown in FIG. 2. When the cathode potential against the anode reached 4.0 V in the 10th charge, the battery was charged to 158.5 mAh/g (93.2% of the theoretical capacity). Similarly, when the cathode potential reached 3.8 V, the battery was charged to 156.3 mAh/g (91.9% of the theoretical capacity). When the cathode potential against the anode reached 2.5 V in the 10th discharge, the battery was discharged to 162.2 mAh/g (95.4% of the theoretical capacity).

A charge/discharge test was conducted on a nonaqueous electrolyte rechargeable battery prepared in the same way for determining its high rate performance. First, the battery was subjected to constant current charge up to a cathode potential against the anode of 4.0 V and then to constant voltage charge down to a current value of not higher than 0.010 mA/cm², at 2.0 C at a constant temperature of 25° C. After that, the battery was discharged at 0.2 C down to a cathode potential against the anode of 2.5 V at a constant temperature of 25° C. Charging and discharging were repeated for ten cycles under the same conditions for initial activation. Then the battery was subjected to constant current charge up to a cathode potential against the anode of 4.0 V and then to constant voltage charge down to a cathode current density of not higher than 0.010 mA/cm², at 2.0 C at a constant temperature of 25° C. After that, the battery was discharged at 0.2 C down to a cathode potential against the anode of 2.5 V at a constant temperature of 25° C. The discharge capacity was 145.0 mAh/g. Nonaqueous electrolyte rechargeable batteries which had been subjected to similar initial activation, were discharged at 1.0 C and 2.0 C. The discharge capacities were 136.6 mAh/g and 131.5 mAh/g, respectively.

### Example 2

LiFePO₄ coated with a carbonaceous material was prepared in the same way as in Example 1, except that the pH of the mixture of Solutions 1 to 3 prepared in Example 1 was 4.3. The specific surface area and powder X-ray diffraction pattern under Condition B of the LiFePO₄ before coating with the carbonaceous material, and the charge/discharge characteristics of the LiFePO₄ after the coating were determined in the same way as in Example 1. The results are shown in Table 1.

### Example 3

LiFePO₄ coated with a carbonaceous material was prepared in the same way as in Example 1, except that the pH of the mixture of Solutions 1 to 3 prepared in Example 1 was 4.7. The specific surface area and powder X-ray diffraction pattern under Condition B of the LiFePO₄ before coating with the carbonaceous material, and the charge/discharge characteristics of the LiFePO₄ after the coating were determined in the same way as in Example 1. The results are shown in Table 1.

### Comparative Example 1

LiFePO₄ was prepared by solid-phase synthesis. As the raw materials for the synthesis, ammonium phosphate dibasic, oxalic acid iron(II) dihydrate, and lithium hydroxide monohydrate were mixed at 1:1:1 by mole, pulverized and mixed in a ball mill using Φ10 mm zirconia balls under argon atmosphere for 24 hours. The resulting mixture was calcined in argon gas flow at 650° C. for 24 hours, to obtain LiFePO₄.

The obtained LiFePO₄ was coated with a carbonaceous material in the same way as in Example 1. The specific surface area and powder X-ray diffraction pattern under Condition B of the LiFePO₄ before coating with the carbonaceous material, and the charge/discharge characteristics of the LiFePO₄ after the coating were determined in the same way as in Example 1. The results are shown in Table 1.

An enlarged X-ray diffraction pattern of 2θ=15° to 29° is shown in FIG. 3.

### Comparative Example 2

LiFePO₄ coated with a carbonaceous material was prepared in the same way as in Example 1, except that the pH of the mixture of Solutions 1 to 3 prepared in Example 1 was 3.4. The specific surface area and powder X-ray diffraction pattern under Condition B of the LiFePO₄ before coating with the carbonaceous material, and the charge/discharge characteristics of the LiFePO₄ after the coating were determined in the same way as in Example 1. The results are shown in Table 1.

### Comparative Example 3

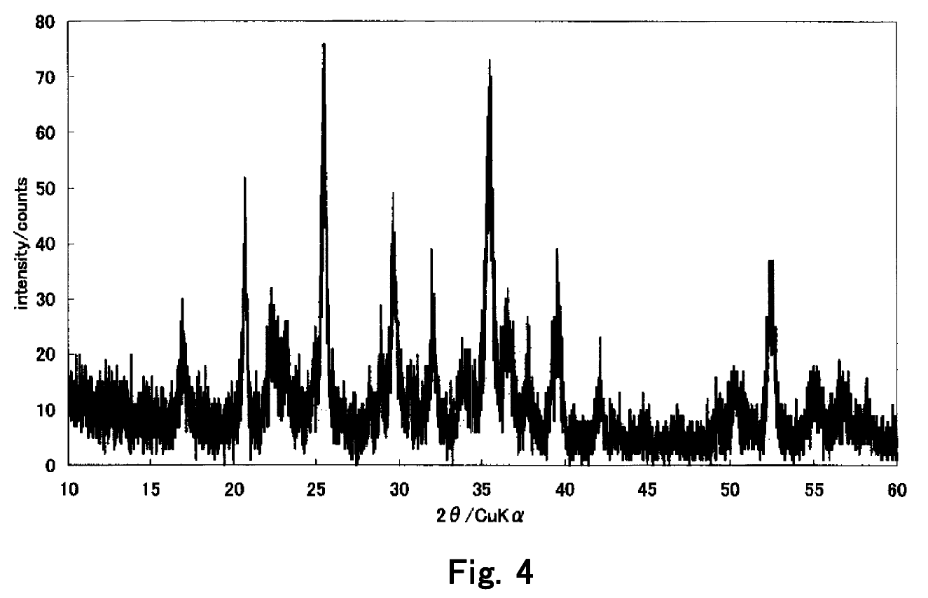

LiFePO₄ coated with a carbonaceous material was prepared in the same way as in Example 1, except that the pH of the mixture of Solutions 1 to 3 prepared in Example 1 was 8.2. The specific surface area and powder X-ray diffraction pattern under Conditions A and B of the LiFePO₄ before coating with the carbonaceous material, and the charge/discharge characteristics of the LiFePO₄ after the coating were determined in the same way as in Example 1. The powder X-ray diffraction pattern under Condition A is shown in FIG. 4, and the rest of the results are shown in Table 1.

TABLE 1

| | | | | Constant voltage charge after | | | Charge/discharge | | |
|---|---|---|---|---|---|---|---|---|---|
| | | | | constant current charge to 4.5 V | | | high rate | | |
| | Specific | Peak | | Charge | Charge | Discharge | performance charge | | |
| | surface | intensity | | capacity | capacity | capacity | to 4.0 V, discharge | | |
| | area | ratio | Peak intensity ratio | at 3.8 V | at 4.0 V | at 2.5 V | to 2.5 V (mAh/g) | | |
| | (m²/g) | I1/I2 | I3/I2 | (mAh/g) | (mAh/g) | (mAh/g) | 0.2 C | 1 C | 2 C |
| Example 1 | 6.45 | 0.0079 | not higher than 0.001 | 156.3 | 158.6 | 162.2 | 145.0 | 136.6 | 131.5 |
| Example 2 | 5.27 | 0.0058 | not higher than 0.001 | 153.9 | 156.3 | 161.8 | 144.8 | 130.2 | 124.3 |
| Example 3 | 5.45 | 0.0049 | not higher than 0.001 | 154.0 | 157.1 | 161.9 | 144.9 | 132.4 | 127.5 |
| Comp. Ex. 1 | 6.32 | 0.0217 | 0.059 | 151.5 | 153.4 | 162.1 | 143.2 | 115.0 | 99.5 |
| Comp. Ex. 2 | 3.07 | 0.0162 | not higher than 0.001 | 143.4 | 145.5 | 156.4 | 134.4 | 112.1 | 101.8 |
| Comp. Ex. 3 | 22.35 | 0.1098 | not higher than 0.001 | 103.7 | 109.7 | 133.5 | 116.0 | 85.8 | 72.1 |

1. A compound having an olivine structure comprising at least lithium, a transition metal, phosphorus, and oxygen, said compound having an olivine structure and a specific surface area of not smaller than 4 m²/g, wherein a highest peak intensity (I1) observed in the range of 2θ=23.00° to 23.70°, a highest peak intensity (I2) observed in the range of 2θ=21.40° to 22.90°, and a highest peak intensity (I3) observed in the range of 2θ=17.70° to 19.70° satisfy I1/I2 of not more than 0.050 and I3/I2 of not more than 0.001, as determined by X-ray diffraction under the following conditions:
Conditions for X-ray diffraction
target: copper; tube voltage: 40 kV; tube current: 300 mA; divergence slit: ½°; scattering slit: 1°; receiving slit: 0.15 mm; operation mode: FT; scan step: 0.01°; exposure time: 2 seconds.

2. The compound according to claim 1, which enables, according to a following battery charge/discharge test, the battery to be charged to not less than 91.0% of its theoretical capacity when a cathode potential against an anode reaches 4.0 V in 10th cycle of charging in step (3):
Charge/Discharge Test
(1) dispersing said compound containing at least lithium, a transition metal, phosphorus, and oxygen and having an olivine structure, in a 10 mass % aqueous glucose solution at a compound-to-carbon ratio of 98.5:1.5 by mass; and drying a resulting dispersion under stirring, and subjecting a dried product to reducing treatment under 5 vol % hydrogen-argon mixed gas atmosphere at 800° C. for 1 hour;
(2) mixing the compound obtained from step (1) with acetylene black as a conductive agent and polyvinylidene fluoride as a binder at a ratio of 80:15:5 by mass, and kneading with N-methylpyrrolidone into slurry; applying said electrode slurry to 20 μm thick aluminum foil, drying, and pressure molding in a press into a thickness of 60 μm; punching a Φ12 mm piece out of said molded product to obtain a cathode having a density of 1.830 to 1.920 g/cm³ exclusive of the aluminum foil; punching a Φ14 mm piece out of 0.15 mm thick lithium foil to obtain an anode, and using porous non-woven polypropylene cloth of 0.025 mm thick as a separator; placing these electrodes in a 2032 coil cell, and charging the cell with an electrolyte prepared by dissolving lithium hexafluorophosphate at 1 mol/l in a 1:2 by volume mixed solution of ethylene carbonate and dimethylcarbonate, to thereby obtain a nonaqueous electrolyte rechargeable battery;
(3) subjecting said nonaqueous electrolyte rechargeable battery prepared in step (2) to constant current charge up to a cathode potential against the anode of 4.5 V and then to constant voltage charge down to a cathode current density of not higher than 0.010 mA/cm², at 0.2 C at a constant temperature of 25° C.;
(4) after said charging in step (3), discharging the battery at 0.2 C down to a cathode potential against the anode of 2.5 V at a constant temperature of 25° C.; and
(5) repeating steps (3) and (4).

3. The compound according to claim 1, further comprising an electrically conductive substance at least partly over its surface.

4. The compound according to claim 3, wherein said electrically conductive substance is a carbonaceous material.

5. A cathode for nonaqueous electrolyte rechargeable batteries comprising a compound of claim 1.

6. A nonaqueous electrolyte rechargeable battery comprising a cathode for nonaqueous electrolyte rechargeable batteries of claim 5.
